(19) United States
(12) Patent Application Publication
(10) Pub. No.: US 2025/0088378 A1
(43) Pub. Date: Mar. 13, 2025

(54) COMMUNICATION APPARATUS, CONTROL METHOD, AND RECORDING MEDIUM

(71) Applicant: CANON KABUSHIKI KAISHA, Tokyo (JP)

(72) Inventors: HIDEAKI OHSHIMA, Kanagawa (JP); HIROKI SAKAKI, Tokyo (JP)

(21) Appl. No.: 18/826,932

(22) Filed: Sep. 6, 2024

(30) Foreign Application Priority Data
Sep. 8, 2023 (JP) 2023-145933
Feb. 29, 2024 (JP) 2024-030504

(51) Int. Cl. H04L 12/12

(52) U.S. Cl. CPC H04L 12/12

(57) ABSTRACT

A communication apparatus communicating with an external device terminal, the communication apparatus includes a communication unit configured to receive an activation packet from the external device terminal, and a control unit configured, in a case where the communication apparatus is in a power saving state when the communication unit receives the activation packet, to perform processing for restoring the communication apparatus from the power saving state, and in a case where the communication apparatus is in an activated state when the communication unit receives the activation packet, to perform processing including a transition of the communication apparatus to the power saving state.

### BACKGROUND

### Field of the Disclosure

The present disclosure relates to a communication system for an external device terminal and a communication apparatus, and in particular to restoration processing by remote control.

### Description of the Related Art

To restore a sleeping information apparatus, such as a personal computer (PC), through a remote operation, there is Wake On Lan (hereinafter, referred to as WOL) as a conventional technique. WOL is generally used to activate, from the outside, an apparatus that is not in use in a sleep state for reducing its power consumption. For example, there has been disclosed a technique of WOL remotely resuming a terminal in a power saving mode (also referred to as a power saving state) (Japanese Patent Application Laid-Open No. 2007-115022).

The above-described conventional technique in Japanese Patent Application Laid-Open No. 2007-115022 includes monitoring whether a cancel signal to a received communication request is received in remotely resuming the terminal in the power saving mode by WOL. In response to a reception of a cancel signal, the operation of the terminal is transitioned into the power saving mode. In other words, only the power saving mode allows the terminal to receive a WOL packet. If some cause brings the remotely operated terminal into a state where the remotely operated terminal cannot return a response, a remote operation cannot be normally performed, which involves a manual reset of the terminal. In such a situation, it is desirable that the terminal can be reset (reactivated) through a remote operation.

### SUMMARY

The present disclosure is directed to a technique providing functions of a restoration from a power saving mode, and of a reset of a remote operation disabled state with a WOL packet transmitted from an external device terminal.

According to an aspect of the present disclosure, a communication apparatus communicating with an external device terminal, the communication apparatus includes a communication unit configured to receive an activation packet from the external device terminal, and a control unit configured, in a case where the communication apparatus is in a power saving state when the communication unit receives the activation packet, to perform processing for restoring the communication apparatus from the power saving state, and in a case where the communication apparatus is in an activated state when the communication unit receives the activation packet, to perform processing including a transition of the communication apparatus to the power saving state.

Further features of the present disclosure will become apparent from the following description of exemplary embodiments with reference to the attached drawings.

### BRIEF DESCRIPTION OF THE DRAWINGS

FIGS. 1A and 1B are block diagrams illustrating the configuration of a communication apparatus according to one or more aspects of the present disclosure.

FIG. 2 is a conceptual diagram illustrating a sleep restoration according to one or more aspects of the present disclosure.

FIG. 3 is a flowchart illustrating sleep restoration processing on the communication apparatus according to one or more aspects of the present disclosure.

FIG. 4 is a conceptual diagram of a reset according to one or more aspects of the present disclosure.

FIG. 5 is a flowchart illustrating a reset processing on the communication apparatus according to one or more aspects of the present disclosure.

FIG. 6 is a flowchart illustrating Wake On Lan (WOL) setting determination processing at the time of the execution of an automatic power-off according to one or more aspects of the present disclosure.

FIG. 7 is a flowchart illustrating the WOL setting determination processing at the time of a reception of a packet according to one or more aspects of the present disclosure.

### DESCRIPTION OF THE EMBODIMENTS

Exemplary embodiments of the present disclosure will now be described in detail with reference to the accompanying drawings. The exemplary embodiments described in the following are examples as means for implementing the present disclosure, and can be appropriately corrected or changed depending on the configuration of an apparatus to which the present disclosure is applied and various kinds of condition. Further, the exemplary embodiments can be appropriately combined.

A first exemplary embodiment will be described. In the present exemplary embodiment, the following is a description of a communication apparatus according to the present disclosure mounted on an imaging apparatus, such as a digital camera. However, the communication apparatus is not limited to the present exemplary embodiment. The communication apparatus according to the present exemplary embodiment of the present disclosure can be applied to an information processing apparatus, such as a mobile phone, a portable media player, a so-called tablet device, and a personal computer.

In the present exemplary embodiment, an external device terminal will be described as a personal computer (PC) (hereinafter, a PC). However, the external device terminal is not limited thereto. The external device terminal according to the present exemplary embodiment can be similarly applied to an information processing apparatus such as a mobile phone, a portable media player, a so-called tablet device, and a personal computer.

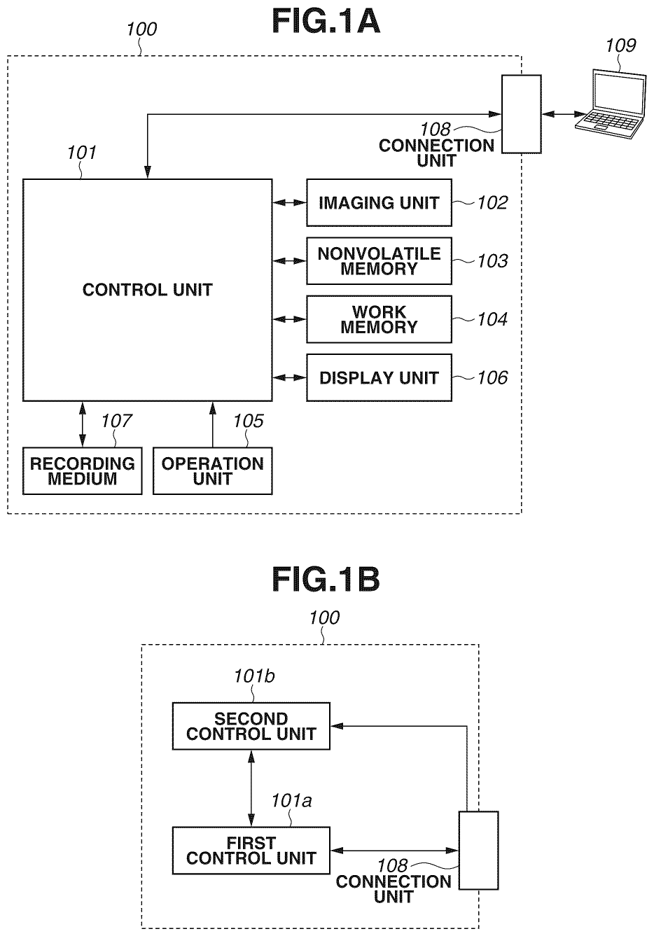

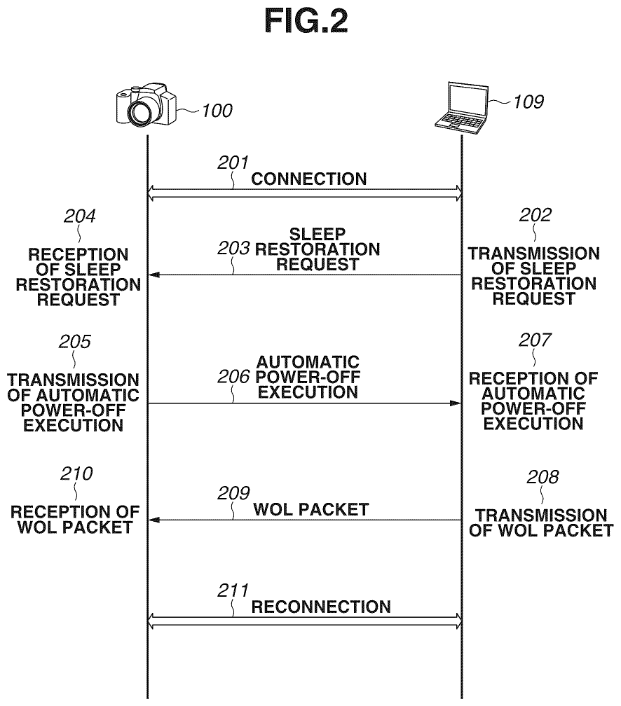

The outline of configurations and functions of the imaging apparatus and the personal computer according to the present exemplary embodiment will be described with reference to FIGS. 1A and 1B, and 2.

In FIGS. 1A and 1B, a control unit 101 controls units of an imaging apparatus 100 based on input signals and programs described below. In place of the control unit 101 generally controlling the apparatus, a plurality of pieces of hardware can share the processing to generally control the apparatus.

The control unit 101 includes a first control unit 101a and a second control unit 101b that are electrically connected to each other. The first control unit 101a is a main central processing unit (CPU), and the second control unit 101b is a sub-CPU. The control unit 101 can include three or more control units.

The first control unit 101a controls a connection unit 108 to communicate with an external device. The communication system is a wireless local area network (LAN) or a wired LAN.

The second control unit 101b is configured, when a Wake On Lan (WOL) packet is received from the external device, to receive an interrupt signal from the connection unit 108.

The operation states of the imaging apparatus 100 includes at least an activated state and a power saving state. The activated state indicates a state where the imaging apparatus 100 operates with power supplied to both the first control unit 101a and the second control unit 101b. The power saving state is a state where power is supplied to the second control unit 101b alone while the imaging apparatus 100 operates on low power consumption compared with that of the activated state.

In the present exemplary embodiment, when the WOL packet is received from the external device, a sleep restoration processing or a reset processing is performed. The sleep restoration processing is processing for bringing the imaging apparatus 100 from the power saving state into the activated state. Even in a state where power is not supplied to the first control unit 101a, the second control unit 101b can receive the interrupt signal when the WOL packet is received from the external device, allowing the imaging apparatus 100 to be brought into the activated state. The reset processing is processing for reactivating the imaging apparatus 100 when the imaging apparatus 100 is put into a remote operation disabled state due to some cause. For example, even in a state where the first control unit 101a is uncontrollable due to some cause, the second control unit 101b can receive the interrupt signal when the WOL packet is received from the external device, allowing the imaging apparatus 100 to be reactivated. This can eliminate the issue with a state where the first control unit 101a is uncontrollable.

An imaging unit 102 converts object light image formed by a lens included in the imaging unit 102 into an electric signal, performs noise reduction processing, and outputs digital data as image data. The captured image data is stored in a buffer memory and then subjected to a predetermined calculation by the control unit 101, and the resultant data is recorded in a recording medium 107.

A nonvolatile memory 103 is an electrically erasable/recordable nonvolatile memory, and stores programs described below to be executed by the control unit 101.

A work memory 104 is used as a buffer memory temporarily holding the image data captured by the imaging unit 102, an image display memory for a display unit 106, and a work area for the control unit 101.

An operation unit 105 is used to receive an instruction to the imaging apparatus 100 from a user. The operation unit 105 includes operation members, such as a power button for turning-on/off a power supply of the imaging apparatus 100, a release switch for imaging, and a playback button for the playback of image data. A touch panel provided on the display unit 106 described below is also included in the operation unit 105.

The release switch includes switches SW1 and SW2. A half-press on the release switch turns on the switch SW1. In response thereto, an instruction for performing an imaging preparation, such as automatic focus (AF) processing, automatic exposure (AE) processing, automatic white balance (AWB) processing, and flash preliminary emission (EF) processing is received. A full press on the release switch turns on the switch SW2. In response thereto, an instruction for performing imaging is received.

The display unit 106 displays a viewfinder image in imaging, captured image data, characters for an interactive operation screen, and other information. The display unit 106 is not necessarily incorporated in the imaging apparatus 100. It is sufficient for the imaging apparatus 100 to be connected to the internal or external display unit 106, and to have at least a display control function for controlling the display of the display unit 106.

The recording medium 107 can record the image data output from the imaging unit 102.

The recording medium 107 can be attachable to/detachable from the imaging apparatus 100, or can be incorporated in the imaging apparatus 100. In other words, it is sufficient for the imaging apparatus 100 to have at least a unit for accessing the recording medium 107.

The connection unit 108 is a communication unit incorporated in the main body of the imaging apparatus 100. The control unit 101 controls the connection unit 108 to perform communication with the external device. The communication system includes a wireless LAN and a wired LAN.

A PC 109 is an external device connected to the imaging apparatus 100 through the connection unit 108. The external device can be a smartphone, a tablet, or other devices.

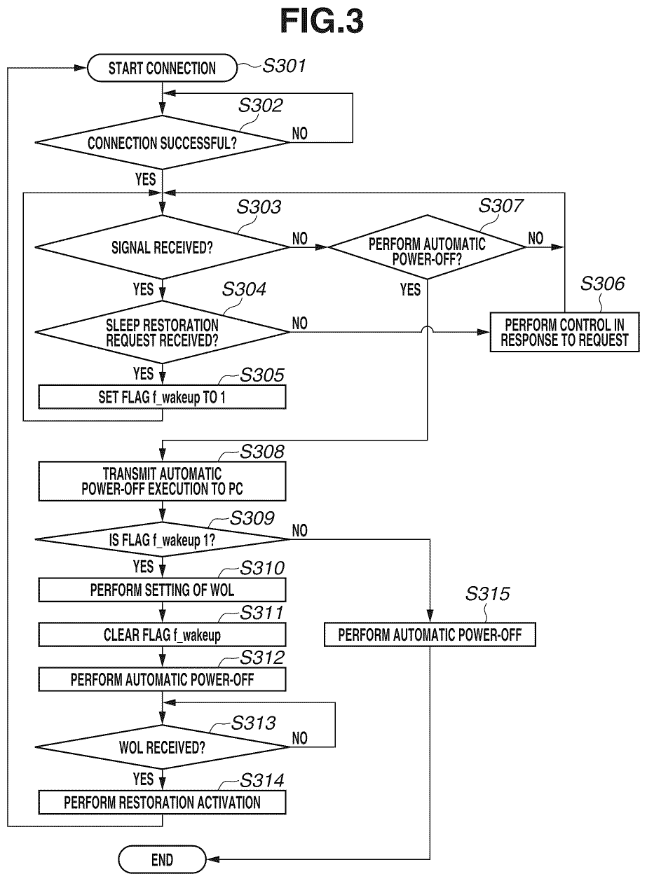

The communication between the imaging apparatus 100 and the PC 109, and a sleep restoration processing procedure according to the first exemplary embodiment of the present disclosure will now be described with reference to FIGS. 2 and 3.

### Sleep Restoration Processing

In step S301, the control unit 101 starts a connection with the PC 109 through the connection unit 108. Thereafter, the processing proceeds to step S302.

In step S302, the control unit 101 performs an operation of connecting to the PC 109 through the connection unit 108, and determines whether the connection is successful. The connection operation includes the establishment of a link of the connection unit 108, the logical establishment of the communication protocol through the connection unit 108.

In FIG. 2, a connection 201 between the imaging apparatus 100 and the PC 109 is established. If the connection is successful (YES in step S302), the processing proceeds to step S303.

In step S303, the control unit 101 determines whether a signal is received from the PC 109 through the connection unit 108. If a signal is received (YES in step S303), the processing proceeds to step S304. If no signal is received (NO in step S303), the processing proceeds to step S307.

In step S304, the control unit 101 determines whether the signal (request information) received from the PC 109 in step S303 is a signal as a sleep restoration request. If the signal is a signal as the sleep restoration request (YES in step S304), the processing proceeds to step S305. If the signal is not a signal as the sleep restoration request (NO in step S304), the processing proceeds to step S306.

In FIG. 2, if the sleep restoration request 203 is transmitted from the PC 109 in step 202, the imaging apparatus 100 receives the sleep restoration request 203 through the connection unit 108 in step 204.

In step S305, if the signal received from the PC 109 in step S304 is a signal as the sleep restoration request, the control unit 101 sets a flag f_wakeup to 1, and the processing proceeds to step S303.

The flag f_wakeup is a flag for determining whether the sleep restoration request is issued from the PC 109. The flag f_wakeup is initialized with the flag f_wakeup=0 at the time of the start of connection. The flag f_wakeup is stored in the work memory 104.

In step S306, if the signal received from the PC 109 is not a signal as the sleep restoration request in step S304, the control unit 101 performs a control for the received request. After the control for the received request is performed, the processing proceeds to step S303. Examples of a request other than the sleep restoration request include an imaging request and an imaging parameter change request. In other words, the request at this time can include a request for remotely operating the imaging apparatus 100 from the PC 109.

In step S307, if no signal is received from the PC 109 in step S303, the control unit 101 determines whether to perform an automatic power-off. If the automatic power-off is performed (YES in step S307), the processing proceeds to step S308. If the automatic power-off is not performed (NO in step S307), the processing proceeds to step S303.

The automatic power-off can be performed with the lapse of a certain time as a trigger.

In step S308, the control unit 101 transmits what is to be executed at the automatic power-off to the PC 109 through the connection unit 108. After the transmission, the processing proceeds to step S309.

In FIG. 2, notification information about an execution of the automatic power-off 206 is transmitted from the imaging apparatus 100 in step 205, and is received by the PC 109 through the connection unit 108 in step 207. The PC 109 receives the notification information about an execution of the automatic power-off 206 through a communication path in step 207, and recognizes what is to be executed by the imaging apparatus 100 at the execution of the automatic power-off.

In step S309, the control unit 101 determines whether the flag f_wakeup is 1. If the flag f_wakeup is 1 as the result of the determination (YES in step S309), the processing proceeds to step S310. If the flag f_wakeup is not 1 as the result of the determination (NO in step S309), the processing proceeds to step S315. In step S315, the processing of the automatic power-off is performed, and the processing ends.

In step S310, the control unit 101 performs the setting for WOL on the connection unit 108. The WOL settings are configured such that, when a WOL packet is received, an interrupt is generated on the control unit 101. The WOL packet is an example of an activation packet. The setting for WOL also refers to a setting for transitioning the WOL function from the disabled state to the enabled state. If the sleep restoration request is received, the control unit 101 switches the setting for WOL from the disabled state to the enabled state at a timing immediately before the operation of the imaging apparatus 100 is transitioned from the activated state into the power saving state. After the WOL settings are configured, the processing proceeds to step S311.

In step S311, the control unit 101 clears the flag f_wakeup. In other words, the control unit 101 sets the flag f_wakeup to 0. After the flag f_wakeup is cleared, the processing proceeds to step S312.

In step S312, the control unit 101 performs the automatic power-off. The imaging apparatus 100 is transitioned from the activated state into the power saving state (power saving mode) where the imaging apparatus 100 is to be restored in response to an event from the outside. Thereafter, the processing proceeds to step S313. In the present exemplary embodiment, the case is described where the control unit 101 is transitioned into the power saving mode, and is restored in response to an event from the outside. However, a sub-CPU including a control unit with less power consumption can be mounted to stop the power supply to the control unit 101. In this case, an event from the outside interrupts the sub-CPU having the control unit with less power consumption than the control unit 101, and the control unit 101 is restored by the sub-CPU.

In step S313, the control unit 101 determines whether an interrupt by WOL is generated. If an interrupt is generated (YES in step S313), the processing proceeds to step S314. If not (NO in step S313), the processing waits for an interrupt by WOL.

In FIG. 2, if a WOL packet 209 is transmitted from the PC 109 in step 208, the imaging apparatus 100 receives the WOL packet 209 through the connection unit 108 in step 210.

In response to the reception of the WOL packet, the connection unit 108 performs an operation for interrupting the control unit 101.

In step S314, the control unit 101 performs the processing for restoring and activating the imaging apparatus 100. To automatically perform the connection processing after the restoration, the processing proceeds to step S301. After the restoration and activation, a reconnection 211 is performed.

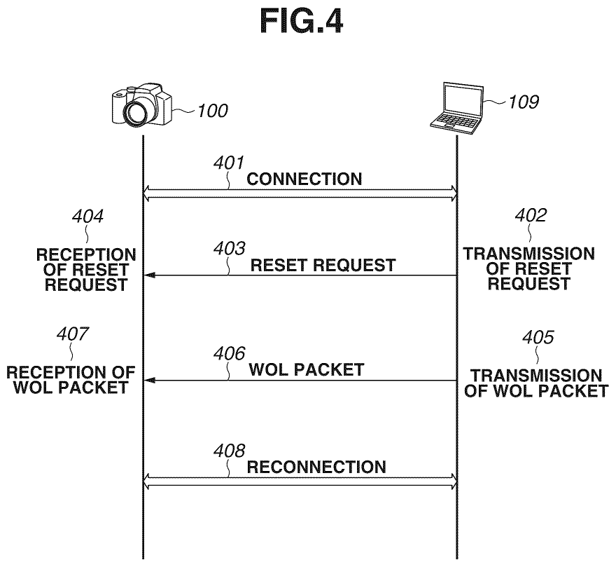

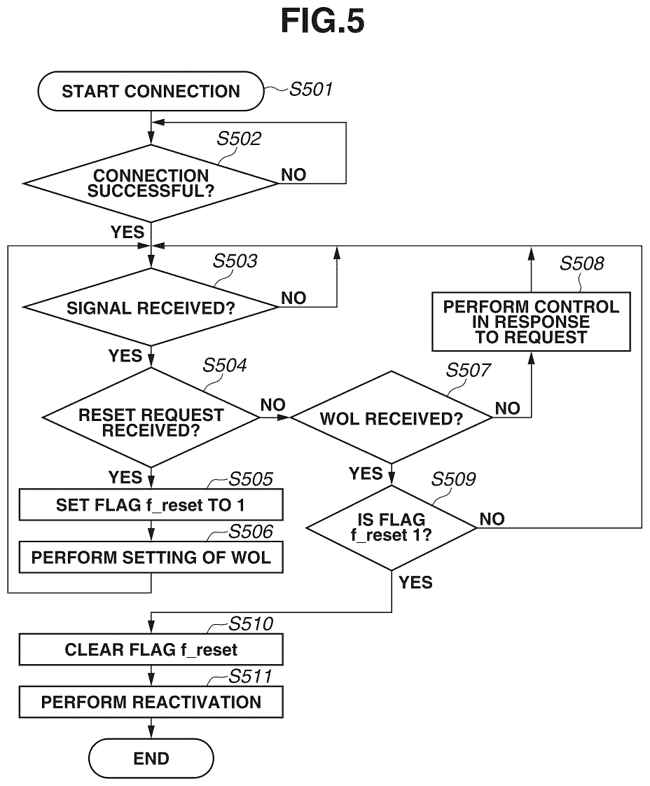

In the following, the communication between the imaging apparatus 100 and the PC 109 and a reset processing procedure according to the first exemplary embodiment of the present disclosure will be described with reference to FIGS. 4 and 5.

### Reset Processing

In step S501, the control unit 101 starts a connection to the PC 109 through the connection unit 108. Thereafter, the processing proceeds to step S502.

In step S502, the control unit 101 performs an operation of connecting to the PC 109 through the connection unit 108, and determines whether the connection is successful. The connection operation includes the establishment of a link of the connection unit 108, the logical establishment of a communication protocol through the connection unit 108. In FIG. 4, a connection 401 between the imaging apparatus 100 and the PC 109 is established. If the connection is successful (YES in step S502), the processing proceeds to step S503.

In step S503, the control unit 101 determines whether a signal is received from the PC 109 through the connection unit 108. If a signal is received (YES in step S503), the processing proceeds to step S504. If no signal is received (NO in step $503), the processing waits for the reception of a signal.

In step S504, the control unit 101 determines whether the signal (request information) received from the PC 109 in step S503 is a signal as a reset request. If the signal is a signal as the reset request (YES in step S504), the processing proceeds to step S505. If the signal is not a signal as the reset request (NO in step S504), the processing proceeds to step S506.

In FIG. 4, if a reset request 403 is transmitted from PC 109 in step 402, the imaging apparatus 100 receives the reset request 403 through the connection unit 108 in step 404.

In step S505, if the signal received from the PC 109 in step S504 is a signal as the reset request, the control unit 101 sets a flag f_reset to 1, and the processing proceeds to step S506. The flag f_reset is a flag for determining whether the reset request is issued from the PC 109. The flag f_reset is initialized with the flag f_reset=0 at the time of the start of connection. The flag f_reset is stored in the work memory 104.

In step S506, the control unit 101 performs the setting for WOL on the connection unit 108. The WOL settings are configured such that, when a WOL packet is received, an interrupt is generated on the control unit 101. In other words, the control unit 101 switches the setting for WOL from the disabled state to the enabled state at a timing immediately after the reset request is received. After the WOL settings are configured, the processing proceeds to step S503.

In step S507, the control unit 101 determines whether the signal received from the PC 109 is a WOL packet. If the WOL packet is received (YES in step S507), the processing proceeds to step S509. If no WOL packet is received (NO in step S507), the processing proceeds to step S508.

In FIG. 4, if a WOL packet 406 is transmitted from the PC 109 in step 405, the imaging apparatus 100 receives the WOL packet 406 through the connection unit 108 in step 407. In response to the reception of the WOL packet, the connection unit 108 performs an operation for interrupting the control unit 101.

In step S508, if the signal received from the PC 109 in step S503 is neither a reset request nor WOL packet, the control unit 101 performs a control for the received request. After the control for the received request is performed, the processing proceeds to step S503. Examples of the request include an imaging request and an imaging parameter change request. In other words, the request at this time can include a request for remotely operating the imaging apparatus 100 from the PC 109.

In step S509, the control unit 101 determines whether the flag f_reset is 1. If the flag f_reset is 1 as the result of the determination (YES in step S509), the processing proceeds to step S510. If the flag f_reset is not 1 as the result of the determination (NO in step S509), the processing proceeds to step S503.

In step S510, the control unit 101 clears the flag f_reset. In other words, the control unit 101 sets the flag f_reset to 0. After the flag f_reset is cleared, the processing proceeds to step S511.

In step S511, the control unit 101 performs the processing for reactivating the imaging apparatus 100. In FIG. 4, a reconnection 408 is performed after the restoration and activation. If the processing ends in order to automatically perform the connection processing after the reactivation, and the imaging apparatus 100 is reactivated, the processing proceeds to step S501 again.

As described above, the imaging apparatus 100, the functions of restoring the imaging apparatus 100 from the power saving mode (automatic power-off) and of resetting the remote operation disabled state can be implemented with a WOL packet transmitted from the external device terminal.

A second exemplary embodiment will be described. In the first exemplary embodiment, the case has been described where the sleep restoration processing and the reset processing each operate independently.

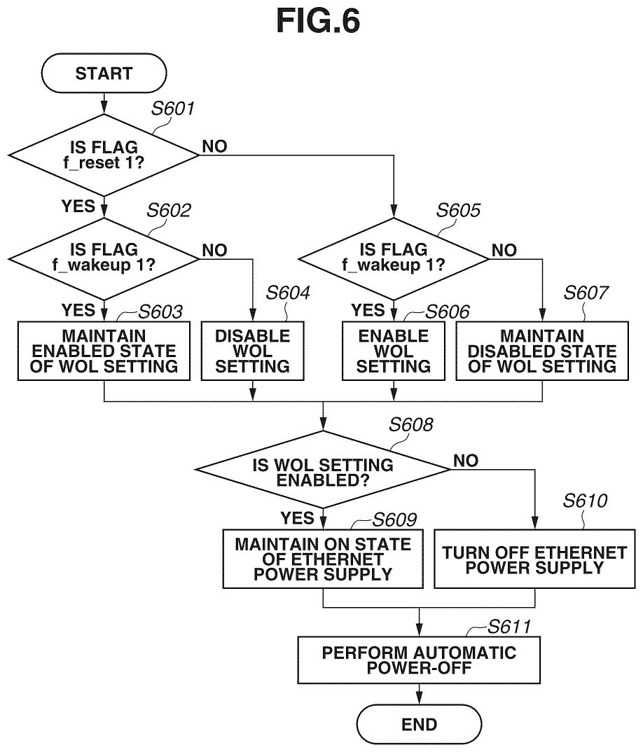

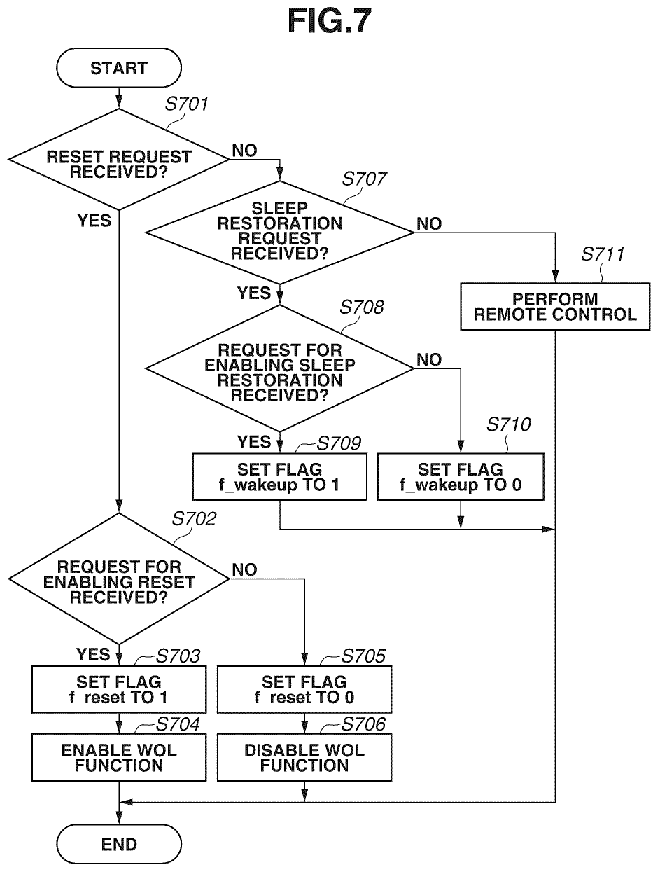

The following is a description of WOL setting determination processing when the sleep restoration processing and the reset processing are performed at a time according to the second exemplary embodiment of the present disclosure with reference to FIGS. 6 and 7.

### WOL Setting Determination Processing at Execution of Automatic Power-Off

The WOL setting determination processing at execution of the automatic power-off will be described. The processing after the processing in step S308 is performed in the first exemplary embodiment will be described.

In step S601, the control unit 101 determines whether the flag f_reset is 1. If the flag f_reset is 1 as the result of the determination (YES in step S601), the processing proceeds to step S602. If the flag f_reset is not 1 as the result of the determination (NO in step S601), the processing proceeds to step S605. The case where the flag f_reset is 1 indicates a state after the control unit 101 has already performed the WOL setting on the connection unit 108.

In step S602, the control unit 101 determines whether the flag f_wakeup is 1. If the flag f_wakeup is 1 as the result of the determination (YES in step S602), the processing proceeds to step S603. If the flag f_wakeup is not 1 as the result of the determination (NO in step S602), the processing proceeds to step S604.

In step S603, the control unit 101 performs no processing since the WOL settings are already enabled. Since the flag f_reset is 1 and the flag f_wakeup is 1, both the requests are enabled. In this case, the WOL settings are already enabled when the reset request is received. Thus, the control unit 101 maintains the WOL settings without performing processing. Thereafter, the processing proceeds to step S608.

In step S604, the control unit 101 disables the WOL settings. Since the flag f_reset is 1 and the flag f_wakeup is 0, the reset request is enabled. In this case, the WOL settings are enabled when the flag f_reset is received, but the restoration processing at the automatic power-off is not performed. Thus, the WOL settings are disabled. Thereafter, the processing proceeds to step S608.

In step S605, the control unit 101 determines whether the flag f_wakeup is 1. If the flag f_wakeup is 1 as the result of the determination (YES in step S605), the processing proceeds to step S606. If the flag f_wakeup is not 1 as the result of the determination (NO in step S605), the processing proceeds to step S607.

In step S606, the control unit 101 enables the WOL settings. Since the flag f_reset is 0 and the flag f_wakeup is 1, the sleep restoration request is enabled. In this case, the WOL settings are not enabled. Thus, the WOL settings are enabled in order to perform the restoration processing at the automatic power-off. Thereafter, the processing proceeds to step S608.

In step S607, the control unit 101 performs no processing since the WOL settings are already disabled. Since the flag f_reset is 0 and the flag f_wakeup is 0, both the requests are disabled. In this case, no processing is necessary since the WOL settings are unrequired. Thereafter, the processing proceeds to step S608.

In step S608, the control unit 101 determines whether the WOL settings are enabled. If the WOL settings are enabled (YES in step S608), the processing proceeds to step S609. If the WOL settings are disabled (NO in step S608), the processing proceeds to step S610.

In step S609, since the WOL settings are enabled, the control unit 101 does not turn off an Ethernet power supply, and the processing proceeds to step S611.

In step S610, since the WOL settings are disabled, the control unit 101 turns off the Ethernet power supply, and the processing proceeds to step S611.

In step S611, the control unit 101 performs the automatic power-off. The imaging apparatus 100 is put into the power saving mode in which the imaging apparatus 100 is to be restored in response to an event from the outside.

### WOL Setting Determination Processing at Packet Reception

WOL setting determination processing at packet reception will be described. The processing after the processing in step S503 or S303 is performed in the first exemplary embodiment will be described.

In step S701, the control unit 101 determines whether the received signal is a signal as the reset request. If the received signal is a signal as the reset request (YES in step S701), the processing proceeds to step S702. If the received signal is not a signal as the reset request (NO in step S701), the processing proceeds to step S707.

In step S702, the control unit 101 determines whether the received reset request is a request for enabling the reset or a request for disabling the reset. If the received reset request is a request for enabling the reset (YES in step S702), the processing proceeds to step S703. If the received reset request is a request for disabling the reset (NO in step S702), the processing proceeds to step S705.

In step S703, the control unit 101 sets the flag f_reset to 1, and the processing then proceeds to step S704. The flag f_reset is a flag for determining whether the reset request is issued from the PC 109.

In step S704, the control unit 101 performs the setting for WOL on the connection unit 108. The WOL settings are configured such that, when a WOL packet is received, an interrupt is generated on the control unit 101. After the settings are configured, the processing ends.

In step S705, the control unit 101 sets the flag f_reset to 0, and the processing then proceeds to step S706. The flag f_reset set to 0 indicates that the reset is not requested from the PC 109 or the reset request is a request for disabling the reset.

In step S706, the control unit 101 performs the setting of disabling the WOL settings on the connection unit 108. The setting of disabling of the WOL settings is performed such that, when a WOL packet is received, an interrupt is not generated on the control unit 101. After the setting is performed, the processing ends.

In step S707, the control unit 101 determines whether the received signal is a signal as the sleep restoration request.

If the received signal is s signal as the sleep restoration request (YES in step S707), the processing proceeds to step S708. If the received signal is not a signal of the sleep restoration request (NO in step S707), the processing proceeds to step S711.

In step S708, the control unit 101 determines whether the received sleep restoration request is a request for enabling the sleep restoration or a request for disabling the sleep restoration. If the received request is a request for enabling the sleep restoration (YES in step S708), the processing proceeds to step S709. If the received request is a request for disabling the sleep restoration (NO in step S708), the processing proceeds to step S710.

In step S709, the control unit 101 sets the flag f_wakeup to 1, and the processing then ends. The flag f_wakeup is a flag for determining whether the sleep restoration request is issued from the PC 109.

In step S710, the control unit 101 sets the flag f_wakeup to 0, and the processing then ends. The flag f_wakeup set to 0 indicates that the sleep restoration is not requested from the PC 109, or the request is a request for disabling the sleep restoration.

In step S711, the control unit 101 performs a control for the received request. After the control unit 101 performs the control for the request, the processing ends. Examples of the received request include an imaging request and an imaging parameter change request. In other words, the request at this time can include a request for remotely operating the imaging apparatus 100 from the PC 109.

As described above, even in the case where the functions of restoring the imaging apparatus 100 from the power saving mode (automatic power-off) and of resetting the remote operation disabled state operate at a time in the imaging apparatus 100, both the functions can be implemented with a WOL packet transmitted from the external device terminal.

In the present exemplary embodiment, the sleep restoration request and the reset request are both issued from the PC 109 but can be stored in the communication apparatus. Further, both the requests can be set for use together.

While the exemplary embodiments of the present disclosure have been described above, the present disclosure is not limited to these exemplary embodiments, and can be variously modified and changed within the scope of the spirit.

### OTHER EXEMPLARY EMBODIMENTS

The present disclosure can be implemented by the following processing. The processing is performed by software (programs) implementing the functions of the above-described exemplary embodiments being supplied to a system or an apparatus through a network or various kinds of storage media, and a computer (or a control unit, a microprocessor unit (MPU), etc.) of the system or the apparatus reading and executing the program codes. In this case, the programs and the storage medium storing the programs are included in the present disclosure.

While the present disclosure has been described in detail based on the exemplary embodiments, the present disclosure is not limited to these specific exemplary embodiments, and various forms without departing from the spirit of the present disclosure are also included in the present disclosure. The above-described exemplary embodiments can be partially combined as appropriate.

The functional units in the above-described exemplary embodiments (modifications) can be individual pieces of hardware or not. The functions of two or more functional units can be implemented with a piece of hardware. Each of the functions of one functional unit can be implemented with an individual piece of hardware. Two or more functions of one functional unit can be implemented with a piece of hardware. The functional units can be implemented with hardware, such as an application specific integrated circuit (ASIC), a field programmable gate array (FPGA), and a digital signal processor (DSP), or not. For example, the apparatus can include a processor and a memory (storage medium) storing control programs. Further, the function(s) of at least a part of the functional units included in the apparatus can be implemented by the processor reading and executing the control programs from the memory.

The present disclosure can be implemented by programs implementing one or more functions of the above-described exemplary embodiments being supplied to a system or an apparatus through a network or a storage medium, and one or more processors of a computer in the system or the apparatus reading and executing the programs. Further, the present disclosure can be realized with a circuit (e.g., ASIC) implementing one or more functions.

### Configuration 1

A communication apparatus communicating with an external device terminal, the communication apparatus comprising:
a control unit configured to enable or disable a WOL function of the communication apparatus based on request information for requesting a transition of the WOL function; and
a communication unit configured to receive an activation packet from the external device terminal,
wherein, in a case where the communication unit receives the activation packet while the WOL function is enabled, the control unit performs processing for activating or reactivating the communication apparatus based on an operation state of the communication apparatus.

### Configuration 2

The communication apparatus according to configuration 1,
wherein, in a case where the operation state of the communication apparatus is a power saving state, the control unit performs processing for activating the communication apparatus from the power saving state, and
wherein, in a case where the operation state of the communication apparatus is an activated state, the control unit performs processing for reactivating the communication apparatus.

### Configuration 3

The communication apparatus according to configuration 2, wherein the control unit transitions the WOL function of the communication apparatus from a disabled state to an enabled state based on request information for enabling the WOL function.

### Configuration 4

The communication apparatus according to configuration 3,
wherein the request information includes a restoration request or a reset request,
wherein, in a case where the request information includes the restoration request, the control unit transitions the WOL function from the disabled state to the enabled state at a timing immediately before the operation state of the communication apparatus is transitioned from the activated state to the power saving state, and
wherein, in a case where the request information includes the reset request, the control unit transitions the WOL function from the disabled state to the enabled state at a timing when the operation state of the communication apparatus is the activated state.

### Configuration 5

The communication apparatus according to configuration 4, wherein, in the case where the request information includes the reset request, the control unit transitions the WOL function from the disabled state to the enabled state at a timing immediately after the reset request is acquired.

### Configuration 6

The communication apparatus according to any one of configurations 3 to 5, wherein the communication unit receives the request information from the external device terminal.

### Configuration 7

The communication apparatus according to any one of configurations 2 to 6, wherein the communication unit transmits notification information indicating transitioning to the power saving state to the external device terminal at a timing when the operation state of the communication apparatus is transitioned from the activated state to the power saving state.

### Configuration 8

The communication apparatus according to configuration 4 or 5, wherein, in a case where both the restoration request and the reset request are acquired when the operation state of the communication apparatus is transitioned from the activated state to the power saving state, the control unit maintains the enabled state of the WOL function.

### Configuration 9

The communication apparatus according to configuration 4 or 5, wherein, in a case where not the restoration request but the reset request alone is acquired when the operation state of the communication apparatus is transitioned from the activated state to the power saving state, the control unit transitions the WOL function from the enabled state to the disabled state.

### Configuration 10

The communication apparatus according to any one of configurations 4 to 9,
wherein the request information includes a request for disabling the restoration request or for disabling the reset request,
wherein, in a case where the request information includes a request for disabling the restoration request, the control unit transitions the WOL function from the enabled state to the disabled state at a timing immediately before the operation state of the communication apparatus is transitioned from the activated state to the power saving state, and
wherein, in a case where the request information includes a request for disabling the reset request, the control unit transitions the WOL function from the enabled state to the disabled state at a timing when the operation state of the communication apparatus is the activated state.

### Configuration 11

The communication apparatus according to any one of configurations 1 to 10, wherein the communication apparatus is a camera.

### Method

A method of controlling a communication apparatus communicating with an external device terminal, the mothed causing a computer to:
enable or disable a WOL function of the communication apparatus based on request information for requesting a transition of the WOL function;
receive an activation packet from the external device terminal; and
perform, in a case where the activation packet is received while the WOL function is enabled, processing for activating or reactivating the communication apparatus based on an operation state of the communication apparatus.

### Program

A program causing a computer to function as a communication apparatus communicating with an external device terminal, the communication apparatus comprising a control unit configured to enable or disable a WOL function of the communication apparatus based on request information for requesting a transition of the WOL function, and a communication unit configured to receive an activation packet from the external device terminal,
wherein, in a case where the communication unit receives the activation packet while the WOL function is enabled, the control unit performs processing for activating or reactivating the communication apparatus based on an operation state of the communication apparatus.

According to the exemplary embodiments, a remote control can have improved usability with the functions of restoring an apparatus from a power saving mode (automatic power-off) and of resetting a remote operation disabled state implemented with a WOL packet transmitted from an external device terminal.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-145933, filed Sep. 8, 2023, and No. 2024-030504, filed Feb. 29, 2024, which are hereby incorporated by reference herein in their entirety.

What is claimed is:

1. A communication apparatus communicating with an external device terminal, the communication apparatus comprising:
a communication unit configured to receive an activation packet from the external device terminal; and
a control unit configured, in a case where the communication apparatus is in a power saving state when the communication unit receives the activation packet, to perform processing for restoring the communication apparatus from the power saving state, and in a case where the communication apparatus is in an activated state when the communication unit receives the activation packet, to perform processing including a transition of the communication apparatus to the power saving state.

2. The communication apparatus according to claim 1, wherein the processing including the transition of the communication apparatus to the power saving state is processing for reactivating the communication apparatus.

3. The communication apparatus according to claim 2,
wherein the control unit enables or disables a Wake On Lan (WOL) function of the communication apparatus based on request information for requesting a transition of the WOL function, and
wherein, in a case where the communication unit receives the activation packet while the WOL function is enabled, the control unit performs processing for activating or reactivating the communication apparatus based on an operation state of the communication apparatus.

4. The communication apparatus according to claim 2,
wherein the control unit includes a first control unit and a second control unit, and
wherein the activated state is a state where the first control unit is energized, and the power saving state is a state where the first control unit is not energized.

5. The communication apparatus according to claim 2, wherein the control unit transitions a WOL function of the communication apparatus from a disabled state to an enabled state based on request information for enabling the WOL function.

6. The communication apparatus according to claim 5,
wherein the request information includes a restoration request or a reset request,
wherein, in a case where the request information includes the restoration request, the control unit transitions the WOL function from the disabled state to the enabled state at a timing immediately before an operation state of the communication apparatus is transitioned from the activated state to the power saving state, and
wherein, in a case where the request information includes the reset request, the control unit transitions the WOL function from the disabled state to the enabled state at a timing when the operation state of the communication apparatus is the activated state.

7. The communication apparatus according to claim 6, wherein, in a case where the request information includes the reset request, the control unit transitions the WOL function from the disabled state to the enabled state at a timing immediately after the reset request is acquired.

8. The communication apparatus according to claim 6, wherein, in a case where both the restoration request and the reset request are acquired when the operation state of the communication apparatus is transitioned from the activated state to the power saving state, the control unit maintains the enabled state of the WOL function.

9. The communication apparatus according to claim 6, wherein, in a case where not the restoration request but the reset request alone is acquired when the operation state of the communication apparatus is transitioned from the activated state to the power saving state, the control unit transitions the WOL function from the enabled state to the disabled state.

10. The communication apparatus according to claim 6,
wherein the request information includes a request for disabling the restoration request or for disabling the reset request,
wherein, in a case where the request information includes a request for disabling the restoration request, the control unit transitions the WOL function from the enabled state to the disabled state at a timing immediately before the operation state of the communication apparatus is transitioned from the activated state to the power saving state, and
wherein, in a case where the request information includes a request for disabling the reset request, the control unit transitions the WOL function from the enabled state to the disabled state at a timing when the operation state of the communication apparatus is the activated state.

11. The communication apparatus according to claim 5, wherein the communication unit receives the request information from the external device terminal.

12. The communication apparatus according to claim 1, wherein the communication unit transmits notification information indicating transitioning to the power saving state to the external device terminal at a timing when the operation state of the communication apparatus is transitioned from the activated state to the power saving state.

13. The communication apparatus according to claim 1, wherein the communication apparatus is a camera.

14. A method of controlling a communication apparatus communicating with an external device terminal, the method comprising:
receiving an activation packet from the external device terminal; and
performing, in a case where the communication apparatus is in a power saving state when the activation packet is received, processing for restoring the communication apparatus from the power saving state, and in a case where the communication apparatus is in an activated state when the activation packet is received, processing for transitioning the communication apparatus to the power saving state.

15. A non-transitory computer-readable storage medium which stores a program for causing a computer to execute a method of controlling a communication apparatus, the method comprising:
receiving an activation packet from an external device terminal; and
performing, in a case where the communication apparatus is in a power saving state when a communication unit receives the activation packet, processing for restoring the communication apparatus from the power saving state, and in a case where the communication apparatus is in an activated state when the communication unit receives the activation packet, processing including a transition of the communication apparatus to the power saving state.
